(19) United States
(12) Patent Application Publication
(10) Pub. No.: US 2025/0198746 A1
(43) Pub. Date: Jun. 19, 2025

(54) SYSTEM AND METHOD FOR INSPECTING THICKNESS

(71) Applicant: Electronics and Telecommunications Research Institute, Daejeon (KR)

(72) Inventors: Sang Kyu LIM, Daejeon (KR); Hyun Chul KANG, Daejeon (KR); Yong Kwi LEE, Daejeon (KR); Chang Beom KIM, Daejeon (KR); Ji Yeon SON, Daejeon (KR)

(73) Assignee: Electronics and Telecommunications Research Institute, Daejeon (KR)

(21) Appl. No.: 18/978,827

(22) Filed: Dec. 12, 2024

(30) Foreign Application Priority Data
Dec. 19, 2023 (KR) 10-2023-0185962
Nov. 11, 2024 (KR) 10-2024-0159656

(51) Int. Cl. G01B 11/06

(52) U.S. Cl. CPC G01B 11/06

(57) ABSTRACT

The present invention relates to a system for inspecting a thickness. The system for inspecting a thickness includes at least one light source unit that irradiates an inspection target product with light, a sensor unit that acquires transmitted light image data or transmitted light power data of light transmitted through the inspection target product, and an apparatus for inspecting a thickness that inspects whether the thickness of the inspection target product is defective based on the transmitted light image data or the transmitted light power data.

### CROSS-REFERENCE TO RELATED APPLICATION

This application claims priority to and the benefit of Korean Patent Application No. 10-2023-0185962, filed on Dec. 19, 2023, and of Korean Patent Application No. 10-2024-0159656, filed on Nov. 11, 2024, the disclosures of which are incorporated herein by reference in its entirety.

### BACKGROUND

### 1. Field of the Invention

The present invention relates to a system and method for inspecting a thickness capable of inspecting a thickness defect of a product that occurs during processing or forming manufacturing processes of the product.

### 2. Discussion of Related Art

Numerous products and parts that we encounter in our daily lives are designed and manufactured with various materials, sizes, and shapes to suit their purpose, functions, and use environment. In particular, internal and external cases and various parts of a product are often manufactured by metal or plastic processing and forming processes. Products manufactured by the processing and forming processes undergo a quality inspection process to check whether they are manufactured within an allowable range of a design value and sort defective products. In this case, the thickness of the manufactured or molded product is also an important quality inspection item.

The best way to objectively and quantitatively determine whether the thickness values at various points of the manufactured product satisfy the allowable range is to measure the thickness using a measuring device directly at the corresponding points of the product. Therefore, products with a simple flat structure having a constant single thickness are usually measured directly using a measuring device such as a vernier caliper and then defective products are selected.

In addition, in cases where direct measurement using the vernier caliper is structurally difficult, the actual thickness of the product is measured by physically sampling the corresponding point of the product, which may cause serious irreversible damage to the manufactured product. For example, in the case of products with various three-dimensional structures including curves, it is difficult to select defective products by objectively and quantitatively measuring the thicknesses of the manufactured products at various points in a non-contact, non-destructive method that does not damage the manufactured products.

Recently, methods of measuring a thickness in a non-destructive method by attaching an ultrasonic measuring device to the measurement point have been introduced for products with a thickness of 1 mm or more made of metal or very hard materials. However, this method is difficult to apply because the thickness is measured with unreliable serious errors in very thin thickness measurements of less than 1 mm, and also has a fatal disadvantage that measurement takes a lot of time when multiple measurement points are distributed in various ways.

### SUMMARY OF THE INVENTION

The present invention is directed to providing a system and method for inspecting a thickness capable of inspecting a thickness defect of a product that occurs during the processing or forming manufacturing process of the product.

According to an aspect of the present invention, there is provided a system for inspecting a thickness including at least one light source unit that irradiates an inspection target product with light, a sensor unit that acquires transmitted light image data or transmitted light power data of light transmitted through the inspection target product, and an apparatus for inspecting a thickness that inspects whether the thickness of the inspection target product is defective based on the transmitted light image data or the transmitted light power data.

The light source unit may irradiate laser light.

The light source unit may be composed of a laser light source of at least one of visible light, infrared light, and ultraviolet light according to transmission characteristics of at least one of visible light, infrared light, and ultraviolet light of a material of the inspection target product.

The sensor unit may include at least one transmitted light image acquisition unit that acquires the transmitted light image data, and the transmitted light image acquisition unit may be located at an opposite side of the light source unit with respect to the inspection target product, and acquire the transmitted light image data appearing on the inspection target product by transmitting the light irradiated through the light source unit.

The sensor unit may include at least one optical power sensor that acquires the transmitted light power data, and the optical power sensor may be located at the opposite side of the light source unit with respect to the inspection target product, and measure transmitted light power data of a beam appearing on the inspection target product by transmitting the light irradiated through the light source unit.

The system may further include a beam optical system that forms the light irradiated from the light source unit into a multi-point beam or a line shape beam and irradiates the inspection target product with the formed multi-point beam or line shape beam.

The apparatus for inspecting a thickness may include a memory, and a processor that is connected to the memory, and the processor may adjust a position of at least one of the light source unit and the sensor unit, and inspect whether the thickness of the inspection target product is defective based on the transmitted light image data or the transmitted light power data.

The processor may acquire measurement point information corresponding to the inspection target product, move at least one of the light source unit and the sensor unit to a position corresponding to the measurement point information, and adjust at least one of light emission intensity and a light irradiation direction of the light source unit.

The processor may extract feature information data from the transmitted light image data, and determine whether the thickness of the inspection target product is defective based on the transmitted light image data and the feature information data.

The processor may input the transmitted light image data and the feature information data to an artificial intelligence (AI) model to predict a thickness value of the inspection target product, and when the thickness value is not included within a preset reference range, determine the thickness of the inspection target product as defective, and the AI model may be a model generated by learning ground truth transmitted light image data, feature information data, and thickness value information of reference samples with various thicknesses being the same material as the inspection target product.

The processor may perform statistical analysis on individual feature information included in the feature information data, calculate outlier scores using the statistical analysis result of the individual feature information, apply a weight to the outlier scores for each individual feature information to calculate an integrated outlier score, and compare the integrated outlier score with a preset threshold value to determine whether the thickness of the inspection target product is defective.

The processor may calculate a difference between the feature information data and the feature information data of pre-stored ground truth transmitted light image data, and determine whether the thickness of the inspection target product is defective based on the calculated difference.

The processor may input the transmitted light power data an AI model to predict a thickness value of the inspection target product, and when the thickness value is not included within a preset reference range, determine the thickness of the inspection target product as defective, and the AI model may be a model generated by learning ground truth transmitted light power data and thickness value information of a reference sample with various thicknesses being the same material as the inspection target product.

The processor may calculate an average and a standard deviation of the transmitted light power data, identify outliers based on the calculated average and standard deviation, and compare the transmitted light power data from which the outliers are excluded with a preset threshold value to determine whether the thickness of the inspection target product is defective.

The processor may calculate a difference between the transmitted light power data and pre-stored ground truth transmitted light power data, and determine whether the thickness of the inspection target product is defective based on the calculated difference.

According to another aspect of the present invention, there is provided, a method of inspecting a thickness including collecting, by a processor, transmitted light image data of light transmitted through an inspection target product, extracting, by the processor, feature information data from the transmitted light image data, and inspecting, by the processor, whether a thickness of the inspection target product is defective based on the feature information data of the transmitted light image data.

The method may further include, before the collecting of the transmitted light image data, acquiring, by the processor, measurement point information corresponding to the inspection target product, moving at least one of a light source unit and a transmitted light image acquisition unit to a position corresponding to the measurement point information, and adjusting at least one of light emission intensity and a light irradiation direction of the light source unit.

In the inspecting of whether the thickness of the inspection target product is defective, the processor may inspect whether the thickness of the inspection target product is defective by using at least one of statistical analysis, an artificial intelligence (AI) model, and difference analysis for the transmitted light image data and the feature information data.

According to still another aspect of the present invention, there is provided, a method of inspecting a thickness including collecting, by a processor, transmitted light power data of light transmitted through an inspection target product, and inspecting, by the processor, whether a thickness of the inspection target product is defective based on the transmitted light power data.

The method may further include, before the collecting of the transmitted light power data, acquiring, by the processor, measurement point information corresponding to the inspection target product, moving at least one of a light source unit and an optical power sensor to a position corresponding to the measurement point information, and adjusting at least one of light emission intensity and a light irradiation direction of the light source unit.

In the inspecting of whether the thickness of the inspection target product is defective, the processor may inspect whether the thickness of the inspection target product is defective by using at least one of statistical analysis, an artificial intelligence (AI) model, and difference analysis for the transmitted light power data.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIGS. 1 and 2 are block diagrams schematically illustrating a system for inspecting a thickness of an inspection target product according to an embodiment of the present invention;

FIG. 3A and FIG. 3B are exemplary diagrams for describing a transmitted light image acquired through a laser beam irradiation of a light source unit and a transmitted light image acquisition unit according to an embodiment of the present invention;

FIG. 4 is an exemplary diagram for describing a plurality of light source units and a plurality of transmitted light image acquisition units according to an embodiment of the present invention;

FIG. 5 is an exemplary diagram for describing one light source unit, a beam optical system, and the plurality of transmitted light image acquisition units according to an embodiment of the present invention;

FIG. 6 is an exemplary diagram for describing at least one light source unit, the beam optical system, and the plurality of transmitted light image acquisition units according to an embodiment of the present invention;

FIG. 7A and FIG. 7B are exemplary diagrams for describing a laser beam irradiation of the light source unit and a transmitted light image acquired through a transmitted light image acquisition unit illustrated in FIG. 6;

FIG. 8 is a block diagram schematically illustrating a configuration of an apparatus for inspecting a thickness according to an embodiment of the present invention;

FIG. 9 is an exemplary diagram illustrating a transmitted light image acquired from a reference sample having a known thickness according to an embodiment of the present invention;

FIG. 10 is an exemplary diagram illustrating a photograph of a transmitted light image acquired after irradiating a red laser beam from the same laser light source on reference samples having different thickness values of the same material according to an embodiment of the present invention;

FIGS. 11A to 11C are flowcharts for describing a method of inspecting a thickness according to an embodiment of the present invention;

FIG. 12 is a flowchart for describing a method of determining whether a thickness of an inspection target product is defective using statistical analysis according to an embodiment of the present invention;

FIG. 13 is a flowchart for describing a method of determining whether the thickness of the inspection target product is defective using an artificial intelligence (AI) model according to an embodiment of the present invention;

FIGS. 14 and 15 are block diagrams schematically illustrating a system for inspecting a thickness according to another embodiment of the present invention;

FIG. 16 is an exemplary diagram for describing a plurality of light source units and a plurality of optical power sensors according to another embodiment of the present invention;

FIG. 17 is an exemplary diagram for describing one light source unit, a beam optical system, and a plurality of optical power sensors according to another embodiment of the present invention;

FIG. 18 is an exemplary diagram for describing at least one light source unit, the beam optical system, and the plurality of optical power sensors according to another embodiment of the present invention;

FIGS. 19A to 19C are flowcharts for describing a method of inspecting a thickness of an inspection target product according to another embodiment of the present invention; and

FIG. 20 is an exemplary diagram illustrating a Python code for a statistical analysis method of transmitted light power data according to another embodiment of the present invention.

### DETAILED DESCRIPTION OF EXEMPLARY EMBODIMENTS

Hereinafter, an embodiment of a system for inspecting a thickness and a method according to the present invention will be described with reference to the attached drawings. In the present description, thicknesses of lines, sizes of components, or the like, illustrated in the accompanying drawings may be exaggerated for clarity and convenience of explanation.

In addition, terms to be described below are defined in consideration of functions in the present invention and may be construed in different ways by the intention of users or practice. Therefore, these terms should be defined on the basis of the contents throughout the present specification.

In cases where products to be measured have visible light transmission characteristics above a certain level, a method of measuring a thickness of a product by irradiating light from a general visible light source and then measuring transmitted optical power using an illuminance sensor or an optical power meter installed at a measurement point is also introduced. However, since this method uses a general visible light source that radiates a relatively wide solid angle in all directions, it is difficult to quantitatively and accurately measure incident optical power to be measured irradiated to the measurement point, and thus, even if the received illuminance value or the received light power value is measured, there are many limitations in accurately deriving a relative thickness difference or thickness value at each measurement point with a narrow error range from these measured values.

In addition, in the case of plastic molded products that are manufactured relatively large, such as the inner plastic case of a refrigerator, in the actual production and quality inspection process, non-quantitative methods, such as workers directly tapping the molded products with their hands and selecting products with defective thickness based on workers' physical senses such as hearing and touch as well as their skill level, have been applied to molded products.

Accordingly, the present invention relates to a technology for selecting products with defective thickness that occur during the processing or forming manufacturing process, and provides a technology that enables easy quantitative sorting of products that are manufactured thicker or thinner than a thickness that a good product should satisfy after the manufacturing process at the inspection stage.

In order to improve the conventional subjective and non-quantitative sorting method that relies on the physical sense and skill of workers when sorting out defective products with thickness in the manufacturing and quality inspection process of products having various forms of three-dimensional stereoscopic structures including curves, such as the inner plastic case of a refrigerator, the present invention provides an apparatus and method that objectively and quantitatively measures thickness values at various points of a product, thereby easily sorting out defective products with thicknesses that fall outside the quantitative allowable range.

The present invention is to quantitatively and accurately measure thickness values of multiple points with a narrow error range by a non-contact, non-destructive method that does not damage products even in an environment where it is structurally impossible to measure a thickness using a simple contact-type measuring device such as a vernier caliper, or where it is difficult to measure the thickness by closely contacting an ultrasonic measuring device, thereby quickly and easily select defective thickness products.

In addition, the present invention is intended to overcome the fundamental limitation that when measuring a thickness using a general visible light source radiated in a relatively wide solid angle in all directions and an illuminance sensor or an optical power meter, it is difficult to quantitatively and accurately determine incident optical power irradiated to a measurement point to be measured, and thus even if the received illuminance value or the received light power value is measured, it is very difficult to accurately derive the relative thickness difference or thickness values at each measurement point with a narrow error range from the measured values.

The present invention is to accurately measure thickness values of multiple points with a narrow error range through a non-contact, non-destructive method that does not damage products in the process of selecting defective thickness products of various types of three-dimensional structures including complex curves, and to easily and quickly select the defective thickness products outside the allowable range from the measurement values through objective and quantitative measurement methods without subjective determination of workers.

The present invention relates to a system and method for accurately measuring a thickness at a measurement point of a product with a narrow error range by a non-contact, non-destructive method using a laser light source in a band of visible light, infrared light, or ultraviolet light, and a camera capable of recognizing an image in a wavelength band of the corresponding light source or an optical power sensor in the band of visible light, infrared light, or ultraviolet light, thereby enabling accurate detection of a relative thickness difference with a narrow error range.

The present invention irradiates measurement points of a light-transmitting product whose thickness is to be measured with laser light in the band of visible light, infrared light, or ultraviolet light, which is propagated in a very narrow solid angle, analyzes an image of a laser light pattern transmitted and scattered at an opposite side of the measurement points or the received optical power to measure the thickness, and selects defective thickness products from the measurement. Therefore, the present invention may measure the thickness in a quantitative method without damaging the inspection target product, easily select the defective thickness products from the measurement, and significantly reduce the time for selecting the defective thickness products at various measurement points.

According to the present invention, by using at least one laser light among visible light, infrared light, and ultraviolet light, which maintains a very narrow solid angle and whose optical power is spatially limited and propagated with almost no loss within a distance of several meters, it is possible to quantitatively and accurately measure the incident optical power irradiated to the measurement point, and by determining the measured light reception power at the other side only by the laser light power irradiated to the measurement point and the transmittance due to the thickness of the measurement point, it is possible to measure the thickness with a very narrow error range, thereby selecting the defective thickness products with very high accuracy.

Therefore, the present invention may be easily applied to the manufacturing process of related industrial sites that require thickness measurement of manufactured products and selection inspection of defective thickness products, and may greatly contribute to the efficiency and automation of related manufacturing processes.

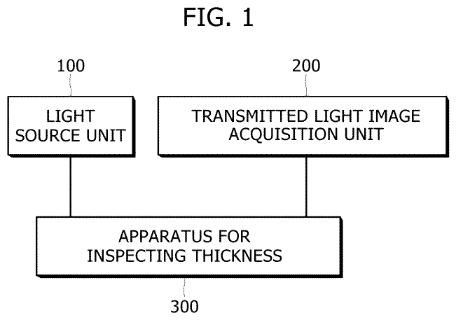

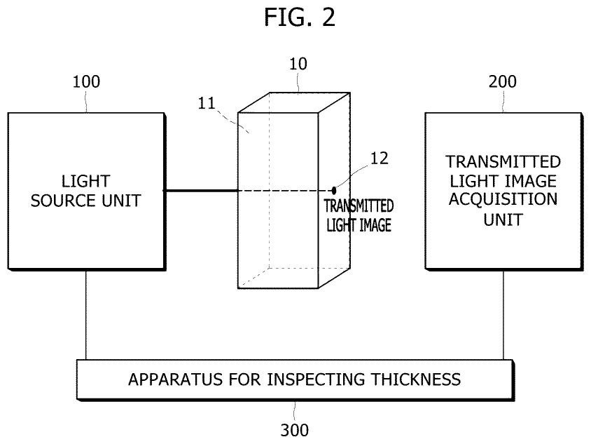

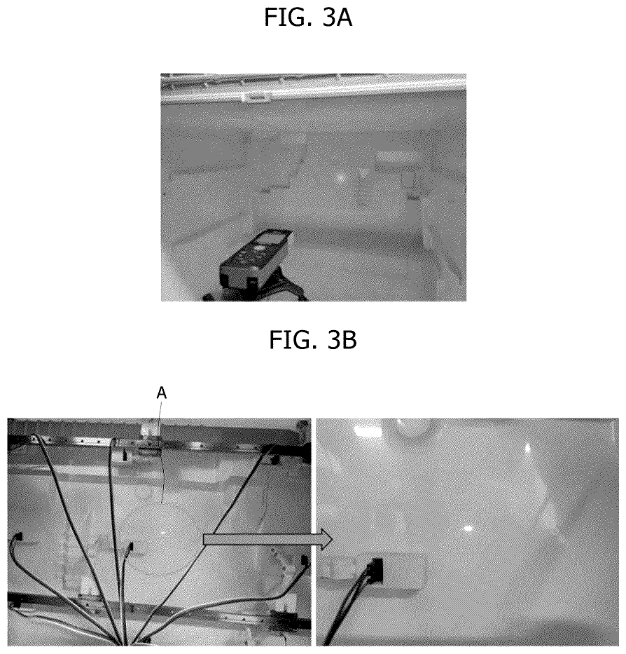

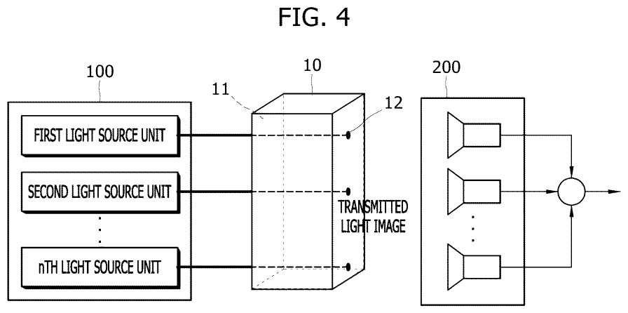

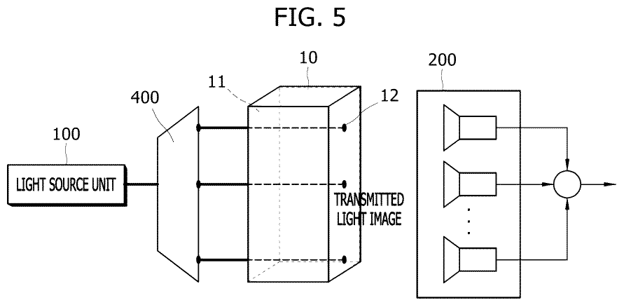

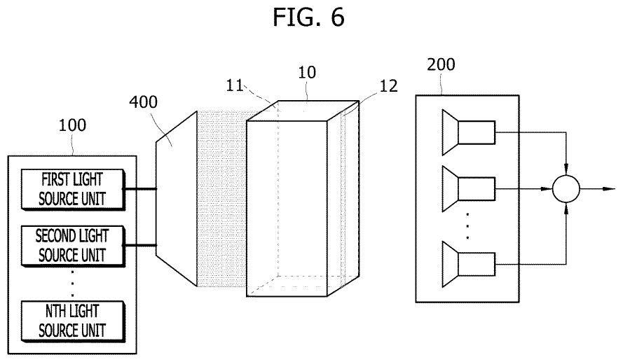

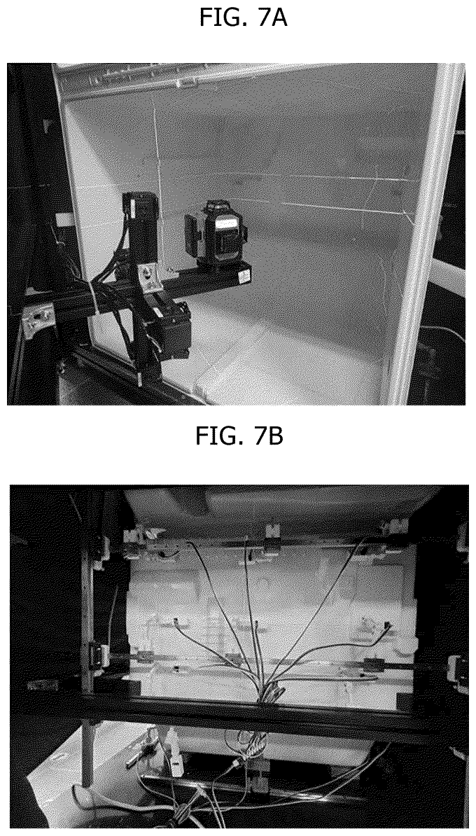

FIGS. 1 and 2 are block diagrams schematically illustrating a system for inspecting a thickness of an inspection target product according to an embodiment of the present invention, FIG. 3 is an exemplary diagram for describing a transmitted light image acquired through a laser beam irradiation of a light source unit and a transmitted light image acquisition unit according to an embodiment of the present invention, FIG. 4 is an exemplary diagram for describing a plurality of light source units and a plurality of transmitted light image acquisition units according to an embodiment of the present invention, FIG. 5 is an exemplary diagram for describing one light source unit, a beam optical system, and the plurality of transmitted light image acquisition units according to an embodiment of the present invention, FIG. 6 is an exemplary diagram for describing at least one light source unit, the beam optical system, and the plurality of transmitted light image acquisition units according to an embodiment of the present invention, and FIG. 7 is an exemplary diagram for describing a laser beam irradiation of the light source unit and a transmitted light image acquired through a transmitted light image acquisition unit illustrated in FIG. 6.

Referring to FIGS. 1 and 2, a system for inspecting a thickness of an inspection target product according to an embodiment of the present invention may include a light source unit 100, a transmitted light image acquisition unit 200, and an apparatus 300 for inspecting a thickness.

The light source unit 100 may irradiate at least one measurement point 12 of the inspection target product 10 whose thickness is to be measured with light. Here, the light may be, for example, laser light (beam). Therefore, the light source unit 100 may be composed of at least one laser light source.

As illustrated in FIG. 2, the light source unit 100 may be positioned in a direction of an open surface 11 of the inspection target product 10, and may irradiate the measurement point 12 on a surface facing the open surface 11 with a laser beam in order to measure a thickness of the measurement point 12 located on a surface facing the open surface 11 and inspect whether the thickness is defective.

The light source unit 100 may selectively apply a laser light source in a band of visible light, infrared light, or ultraviolet light according to transmission characteristics in the band of visible light, infrared light, or ultraviolet light of the material of the inspection target product 10.

The transmitted light image acquisition unit 200 may acquire the transmitted light image (transilluminated lighting image) of light transmitted at the measurement point 12 of the inspection target product 10. In other words, the transmitted light image acquisition unit 200 may acquire the transmitted light image of the laser beam transmitted at the measurement point 12 of the inspection target product 10.

As illustrated in FIG. 2, the transmitted light image acquisition unit 200 is located at the opposite side of the light source unit 100 with respect to the inspection target product 10, and may acquire transmitted light image data in which light irradiated through the light source unit 100 is transmitted and appears on the inspection target product 10.

For convenience of description, the light irradiated from the light source unit 100 will be described as a laser beam.

The transmitted light image, which is transmitted by the laser beam irradiated through the light source unit 100 and appears at the measurement point 12, may be acquired by the transmitted light image acquisition unit 200 located at the opposite side.

The transmitted light image acquisition unit 200 may transmit the acquired transmitted light image data to the apparatus 300 for inspecting a thickness. The transmitted light image data may include transmitted light image acquisition unit identification information and a transmitted light image.

At least one or more transmitted light image acquisition units 200 may be provided to acquire the transmitted light image.

The transmitted light image acquisition unit 200 may be implemented with, for example, a camera, an image sensor, etc., for acquiring the transmitted light image.

The transmitted light image acquisition unit 200 for acquiring the transmitted light image in the band of visible light, infrared light, or ultraviolet light may selectively apply an image acquisition camera or an image sensor in the band of visible light, infrared light, or ultraviolet light, respectively.

For example, as illustrated in FIG. 3A, when the light source unit 100 irradiates a red laser beam, the transmitted light image acquisition unit 200 may acquire a red laser transmitted light image transmitted at a thickness measurement point 12 as illustrated in A of FIG. 3B.

Meanwhile, the light source unit 100 and the transmitted light image acquisition unit 200 may use a plurality of light source units 100 and a plurality of transmitted light image acquisition units 200 as illustrated in FIG. 4 to measure the thickness and select the defective thickness at the plurality of measurement points 12.

In addition, the light source unit 100 and the transmitted light image acquisition unit 200 may use the single light source unit 100, a beam optical system 400, and the plurality of transmitted light image acquisition units 200 as illustrated in FIG. 5 to measure the thickness and select the defective thickness at the plurality of measurement points 12. Here, the beam optical system 400 forms a single laser beam irradiated from the light source unit 100 into a multi-point beam, and may be, for example, a beam distributor and beam path converter.

In addition, the light source unit 100 and the transmitted light image acquisition unit 200 may use at least one light source unit 100, a beam optical system 400, and the plurality of transmitted light image acquisition units 200 as illustrated in FIG. 6 to measure the thickness and select the defective thickness at the plurality of measurement points 12. Here, the beam optical system 400 forms a linear laser beam, and may be, for example, a beam distributor and beam path converter. The plurality of transmitted light image acquisition units 200 may acquire a laser transmitted light linear image formed through the beam optical system 400.

For example, when one or more light source units 100 of FIG. 6 irradiate a green laser beam, the beam optical system 400 forms a green laser linear beam as in FIG. 7A, and the transmitted light image acquisition unit 200 may acquire a green laser transmitted light linear image as in FIG. 7B.

Meanwhile, in the present embodiment, the configuration for acquiring the transmitted light image is described as the transmitted light image acquisition unit 200, but the transmitted light image acquisition unit 200 may also be referred to as a sensor or a sensor unit.

The apparatus 300 for inspecting a thickness may acquire measurement point information corresponding to the inspection target product 10, and move at least one of the light source unit 100, the beam optical system 400, and the transmitted light image acquisition unit 200 to a position corresponding to the measurement point information.

The apparatus 300 for inspecting a thickness may manage and control operations of at least one of the light source unit 100, the beam optical system 400, and the transmitted light image acquisition unit 200. Here, the function of managing and controlling an operation of at least one of the light source unit 100, the beam optical system 400, and the transmitted light image acquisition unit 200 may include adjustment of the position and light emission intensity of the light source of the light source unit 100 and the beam optical system 400, adjustment of the irradiation direction of the laser beam, adjustment of the position of the transmitted light image acquisition unit 200, etc.

The apparatus 300 for inspecting a thickness may inspect whether the thickness of the inspection target product 10 is defective using the transmitted light image data collected from the transmitted light image acquisition unit 200.

The apparatus 300 for inspecting a thickness may be implemented as Internet of Things (IoT), a personal computer (PC), a server, an edge end, etc.

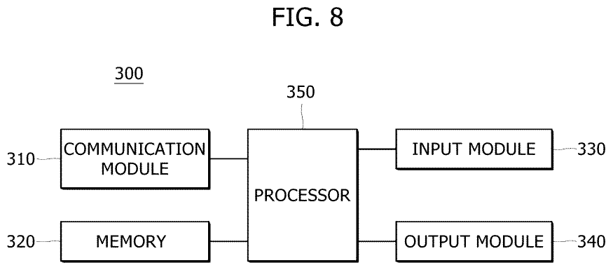

The apparatus 300 for inspecting a thickness will be described in detail with reference to FIG. 8.

Meanwhile, the system for inspecting a thickness configured as described above may be constructed and utilized as a quality inspection system based on a manufacturing digital twin by being interlinked with a standard-based manufacturing digital twin model generation and management system. The standard-based manufacturing digital twin model generation and management system may be a system that generates and manages a digital twin model for quality management, quality improvement, and productivity enhancement of products required in the manufacturing process. The results of inspecting whether the thickness of the inspection target product 10 is defective (abnormal) stored in the apparatus 300 for inspecting a thickness may be utilized by being interlinked with a standard-based manufacturing digital twin model generation and management system, thereby improving and optimizing the quality of manufactured products.

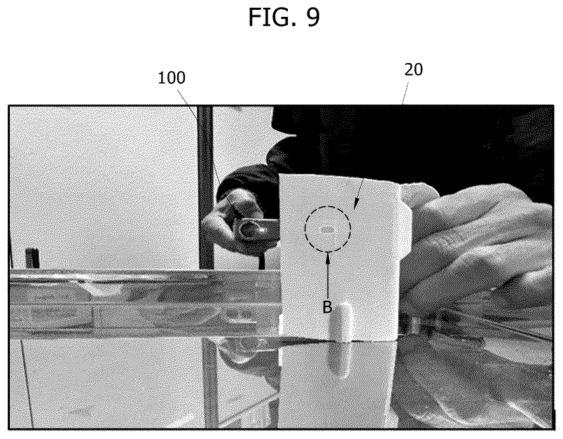

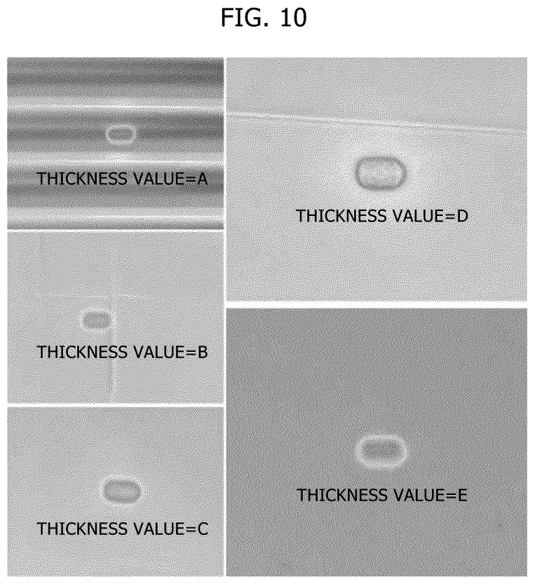

FIG. 8 is a block diagram schematically illustrating a configuration of the apparatus for inspecting a thickness according to an embodiment of the present invention, FIG. 9 is an exemplary diagram illustrating a photograph of a transmitted light image acquired from a reference sample having a known thickness according to an embodiment of the present invention, and FIG. 10 is an exemplary diagram illustrating a photograph of a transmitted light image acquired after irradiating a red laser beam from the same laser light source on reference samples having different thickness values of the same material according to an embodiment of the present invention.

FIG. 8 illustrates the apparatus 300 for inspecting a thickness according to an embodiment of the present invention, which includes a communication module 310, a memory 320, an input module 330, an output module 340, and a processor 350.

The communication module 310 may provide an interface necessary for providing a transmission/reception signal between the apparatus 300 for inspecting a thickness and the light source unit 100, the transmitted light image acquisition unit 200, and at least one of the external devices in the form of packet data by linking with a communication network. In particular, the communication module 310 may transmit the result of determining whether the thickness of the inspection target product 10 is defective inspected by the processor 350 to the external devices. In addition, the communication module 310 may be a device including hardware and software necessary to transmit and receive signals such as a control signal or a data signal through wired and wireless connections with other network devices. In addition, the communication module 310 may be implemented in various forms such as a short-range communication module, a wireless communication module, a mobile communication module, and a wired communication module.

The memory 320 is a configuration that stores data related to the operation of the apparatus 300 for inspecting a thickness. In particular, the memory 320 may store a program (application or applet) that may inspect whether the thickness of the inspection target product is defective (abnormal) based on the transmitted light image data, and the pieces of stored information may be selected by the processor 350 as needed. That is, various types of data generated during the execution of the operating system or application (program or applet) for driving the apparatus 300 for inspecting a thickness are stored in the memory 320. In this case, the memory 320 generally refers to a non-volatile storage device that continues to maintain the stored information even when power is not supplied, and a volatile storage device that requires power to maintain the stored information.

The input module 330 is provided to input information necessary to determine whether the thickness of the inspection target product 10 is defective (abnormal), and may receive inputs such as the type of the inspection target product.

The input module 330 may include, for example, a keyboard, a mouse, a touchpad, a touch panel, a (digital) pen sensor, a key, etc. Here, the key may include, for example, a physical button, an optical key, or a keypad.

The output module 340 may output the results of determining whether the thickness of the inspection target product 10 is defective, the results of the transmitted beam alignment, etc., under the control of the processor 350. The output module 340 may include, for example, a liquid crystal display (LCD), a light emitting diode (LED) display, an organic light emitting diode (OLED) display, or a micro-electro mechanical system (MEMS) display, or an electronic paper display. In addition, the output module 340 may include a speaker, etc.

A user may monitor the results of determining whether the thickness is defective output through the output module 340, and may also control the light source unit 100 and the transmitted light image acquisition unit 200 by looking at the results of the transmitted beam alignment.

Meanwhile, in the embodiment of the present invention, the input module 330 and the output module 340 are described as being implemented separately, but the input module 330 and the output module 340 may also be implemented as an integrated unit.

The processor 350 is a subject that inspects whether the thickness of the inspection target product 10 is abnormal (defective) in the present embodiment, and may be implemented as a central processing unit (CPU) or a system on chip (SoC), and may control a plurality of hardware or software components connected to the processor 350 by driving an operating system or an application and perform various data processing and calculations. The processor 350 may be configured to execute at least one command stored in the memory 320 and store the execution result data in the memory 320.

The processor 350 may acquire the measurement point information corresponding to the inspection target product 10, and move at least one of the light source unit 100 and the transmitted light image acquisition unit 200 to the position corresponding to the measurement point information.

The processor 350 may manage and control the operations of the light source unit 100 and the transmitted light image acquisition unit 200. Here, the function of managing and controlling an operation of at least one of the light source unit 100 and the transmitted light image acquisition unit 200 may include adjustment of the position and light emission intensity of the light source of the light source unit 100 and the beam optical system 400, the adjustment of the irradiation direction of the laser beam, the adjustment of the position of the transmitted light image acquisition unit 200, etc.

The processor 350 may inspect whether the thickness of the inspection target product 10 is defective (abnormal) based on the transmitted light image data received from the transmitted light image acquisition unit 200.

Hereinafter, the operation of the processor 350 inspecting whether the thickness of the inspection target product 10 is defective will be described in detail.

When the inspection target product 10 is selected (or input) through the input module 330, the processor 350 may acquire the measurement point information corresponding to the inspection target product 10 and move the light source unit 100 and the transmitted light image acquisition unit 200 to the position corresponding to the measurement point information.

That is, since the memory 320 stores the measurement point information of each inspection target product 10, when the inspection target product 10 is selected, the processor 350 may acquire the measurement point information corresponding to the selected inspection target product 10. Thereafter, the processor 350 may move the light source unit 100 and the transmitted light image acquisition unit 200 to the position corresponding to the measurement point information. In this case, the light source unit 100 and the transmitted light image acquisition unit 200 may move automatically or manually.

The processor 350 may control (or adjust) the light source of the light source unit 100, the position and light emission intensity of the beam optical system 400, the irradiation direction of the laser beam, the position of the transmitted light image acquisition unit 200, etc.

The apparatus 300 for inspecting a thickness may be provided with an actuator (not illustrated) composed of a motor and a gear, a mechanical device, etc., to move the light source unit 100 and the transmitted light image acquisition unit 200, and the movement of the light source unit 100 and the transmitted light image acquisition unit 200 may be controlled by the apparatus 300 for inspecting a thickness.

When the position control of the light source unit 100 and the transmitted light image acquisition unit 200 is completed, the processor 350 may control the light source unit 100 to irradiate the laser beam and control the transmitted light image acquisition unit 200 to acquire the transmitted light image data.

Thereafter, the processor 350 may collect the transmitted light image data from the transmitted light image acquisition unit 200 and preprocess the collected transmitted light image data. That is, the processor 350 may perform preprocessing tasks such as noise removal, filtering, and scaling on the transmitted light image data.

When the preprocessing is completed on the transmitted light image data, the processor 350 may extract preset feature information from the preprocessed transmitted light image data. Here, the feature information may include color, spectral range, brightness, contrast, optical information, texture, frequency, reference scale, edge characteristic information, and various types of image sensing information. The color may include red, green, blue (RGB) and hue, saturation, and value (HSV). The processor 350 may convert the color space of the transmitted light image from the RGB to the HSV to extract RGB information and HSV information. The RGB is a method of expressing color based on three colors: red, green, and blue, and the HSV expresses color using hue, saturation, and value (or brightness). The optical information may include scattering, refraction, optical flow, etc. The reference scale may be calculated by calculating the ratio and characteristic difference between pixels of the actual image when the image ratio is different in the ground truth images by the thickness. In this case, the processor 350 may extract the feature information based on the pixels of the transmitted light image.

When the feature information of the transmitted light image data is extracted, the processor 350 may determine whether the thickness of the inspection target product 10 is defective by using at least one of the statistical analysis, the AI model, and the difference analysis for the transmitted light image data and feature information data.

In this case, the processor 350 may determine whether the thickness of the inspection target product 10 is defective based on the difference between the ground truth transmitted light image data and the individual feature information of the transmitted light image data. For example, the processor 350 may compare the feature information of the ground truth transmitted light image with the feature information of the transmitted light image to determine whether there is individual feature information that has a difference greater than a preset value. As a result of the determination, when the number of feature information having a difference greater than or equal to a certain value between two pieces of feature information is greater than or equal to a preset number, the processor 350 may determine the thickness of the inspection target product 10 as defective. When the number of feature information having a difference greater than or equal to a certain value between two pieces of feature information is not greater than or equal to a preset number, the processor 350 may determine the thickness of the inspection target product 10 as normal.

In addition, the processor 350 may perform the statistical analysis on the feature information data of the transmitted light image data to determine whether the thickness of the inspection target product 10 is defective. In this case, the processor 350 may perform the statistical analysis, such as the average, standard deviation, and median, for each individual feature using the feature information data of the transmitted light image data of the inspection target product 10. Thereafter, the processor 350 may calculate an outlier score using the statistical analysis results for each individual feature of the transmitted light image data. The processor 350 may combine and sum the outlier scores and weights for each feature information to produce an integrated outlier score for the transmitted light image data. The processor 350 may compare the integrated outlier score with a preset threshold value to determine whether the thickness of the inspection target product 10 is defective. For example, when the integrated outlier score exceeds the threshold value, the processor 350 may determine the thickness of the inspection target product 10 as defective. When the integrated outlier score is lower than or equal to the threshold value, the processor 350 may determine the thickness of the inspection target product 10 as normal. Here, the threshold value may be a value generated based on the ground truth transmitted light image data and feature information data of reference sample 20 of the same material and thickness as the inspection target product 10.

In addition, the processor 350 may apply the feature information data of the transmitted light image data to the AI model to determine whether the thickness of the inspection target product 10 is defective. In this case, the processor 350 may predict the thickness value of the inspection target product 10 through the AI model by inputting the feature information data of the transmitted light image data of the inspection target product 10 to the AI model. The processor 350 may determine whether the predicted thickness value is within a preset reference range. When the predicted thickness value is within the reference range, the processor 350 may determine the thickness of the inspection target product 10 as normal. When the predicted thickness value is not within the reference range, the processor 350 may determine the thickness of the inspection target product 10 as defective.

Here, the AI model may be a model generated based on the ground truth transmitted light image data and the feature information data of the reference sample 20 of various thicknesses of the same material as the inspection target product 10. In other words, the AI model may be a model generated by learning the ground truth transmitted light image data, the feature information data, and the thickness value information. The AI model is generated by collecting the ground truth transmitted light image data and extracting the feature information data of the reference samples 20 before acquiring and collecting the transmitted light image data of the inspection target product 10.

The ground truth transmitted light image data B acquired from the reference sample 20 with the known thickness may be as illustrated in FIG. 9. The ground truth transmitted light image, which is acquired by irradiating the laser beam from the same light source unit 100 to the reference samples 20 with different thickness values of the same material, may be as illustrated in FIG. 10. Referring to FIG. 10, it may be confirmed that the ground truth transmitted light image and feature information are different depending on the thickness value.

Therefore, as the known thickness values of the reference samples 20 input into the AI model vary, the ground truth transmitted light image data and the feature information data collected from reference samples 20 may improve the accuracy of thickness measurement and the thickness defect determination of the inspection target product 10.

The AI model may include machine learning (SVM, isolation random forest, etc.), deep learning algorithms (GAN, AutoEncoder, transfer learning, etc.), and may be applied to predict or classify the thickness quality data of products in linkage with the standard-based manufacturing digital twin system.

The processor 350 may output the result of determining whether the inspection target product 10 has a thickness defect through the output module 340 and store the result in the memory 320.

The result of determining whether the thickness of the inspection target product 10 is defective which is stored in the memory 320 may be utilized for linking with the real-time quality management system for the manufactured product or the standard-based manufacturing digital twin model generation and management system. The result of determining whether the thickness of the inspection target product 10 is defective which is stored in the memory 320 may be utilized in linkage with the standard-based manufacturing digital twin model generation and management system to improve and optimize the quality of the manufactured product.

When the thickness of the inspection target product 10 is determined as defective, the processor 350 may output the defect (abnormality) detection information regarding the thickness value of the inspection target product 10 through the output module 34 or notify the preset user of the defect detection information. In this case, the processor 350 may notify the user of the defect (abnormality) detection information of the thickness value of the inspection target product 10 using a text message, email, social networking service (SNS), etc.

In addition, when the thickness of the inspection target product 10 is determined as defective, the processor 350 may re-collect the transmitted light image data, check whether the light source unit 100 and the transmitted light image acquisition unit 200 are operating normally, and perform the function control.

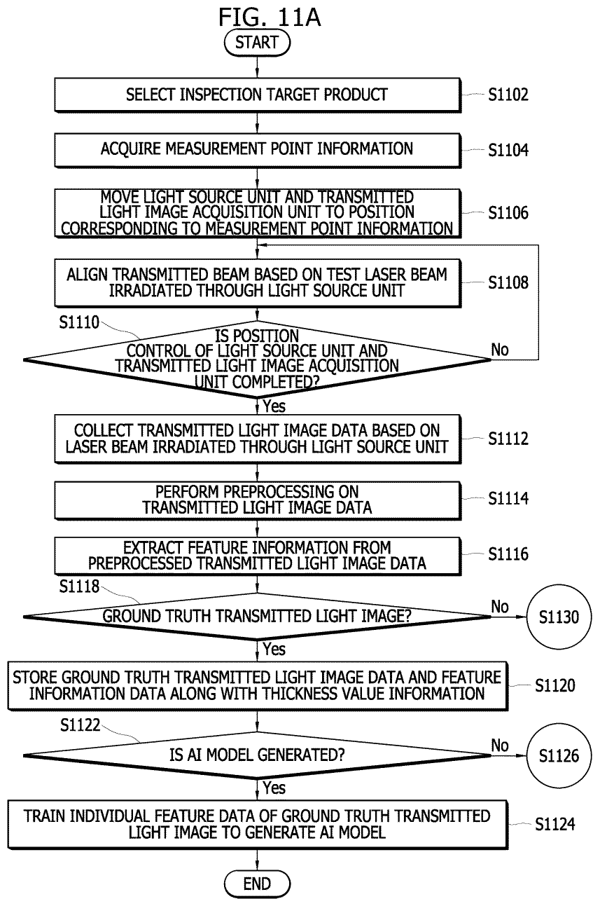

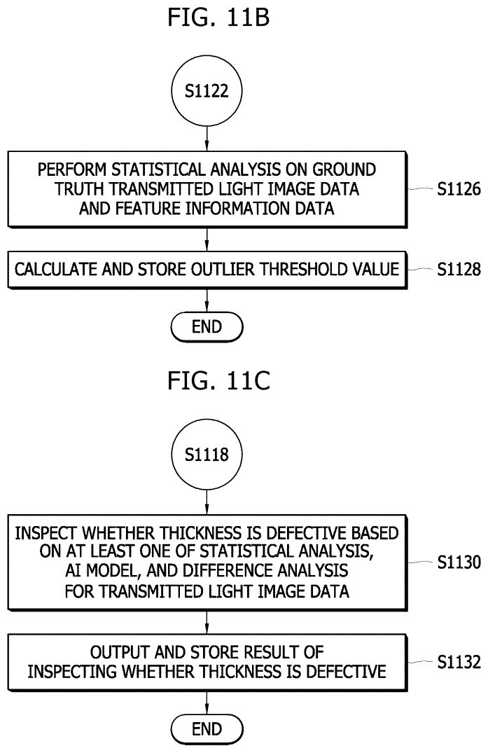

FIGS. 11A to 11C are flowcharts for describing a method of inspecting a thickness according to an embodiment of the present invention.

Referring to FIGS. 11A to 11C, when the inspection target product 10 is selected (S1102), the processor 350 acquires measurement point information corresponding to the inspection target product 10 (S1104), and moves the light source unit 100 and the transmitted light image acquisition unit 200 to the position corresponding to the measurement point information (S1106). In this case, the processor 350 may adjust the positions of the light source unit 100, the beam optical system 400, and the transmitted light image acquisition unit 200, etc.

After operation S1106 is performed, the processor 350 controls the light source unit 100 to irradiate a test laser beam, and performs transmitted beam alignment based on a test transmitted light image acquired by the irradiated test laser beam (S1108).

When the light source unit 100 and the transmitted light image acquisition unit 200 move to the measurement point of the inspection target product 10, the processor 350 may control the light source unit 100 to irradiate test light to determine whether the transmitted beam is properly aligned. The test light irradiated from the light source unit 100 may be transmitted through the thickness measurement point of the inspection target product 10 to generate the test transmitted light image at the opposite side. The transmitted light image acquisition unit 200 may acquire the test transmitted light image generated at the thickness measurement point of the inspection target product 10. The processor 350 may readjust the positions of the light source unit 100 and the transmitted light image acquisition unit 200 so that the acquired test transmitted light image remains is maintained in a clear state and control the light emission intensity and irradiation direction of the light source unit 100, thereby performing the transmitted beam alignment. In addition, the processor 350 may adjust the position of the transmitted light image acquisition unit 200 so that background noise may be excluded as much as possible from the test transmitted light image except for the transmitted light area. This may improve the accuracy of thickness quality inspection and thickness defect selection of the inspection target product 10 by minimizing the influence of background noise light in the transmitted light image data analysis process later.

When the position control for the light source unit 100 and the transmitted light image acquisition unit 200 is completed by performing operation S1108 (S1110), the processor 350 collects transmitted light image data based on the light irradiated through the light source unit 100 (S1112). That is, the processor 350 may control the light source unit 100 to irradiate a laser beam. The light source unit 100 may generate and irradiate a laser beam. The laser beam irradiated by the light source unit 100 may be transmitted from the thickness measurement point of the inspection target product 10 to generate the transmitted light image at the opposite side, and the transmitted light image acquisition unit 200 may acquire the generated transmitted light image and transmit the acquired transmitted light image data to the processor 350.

When operation S1112 is performed, the processor 350 performs the preprocessing on the collected transmitted light image data (S1114).

In this case, the processor 350 may collect video image data or image data in one frame from the transmitted light image acquisition unit 200 to acquire the transmitted light image of the laser beam in the band of visible light, infrared light, or ultraviolet light irradiated in a very narrow solid angle. In this case, when the video image data is input, the processor 350 may divide the input image data into units of frames and convert the input image data into an image.

The processor 350 may select an image area of a specific transmitted light area suitable for the thickness quality inspection based on the transmitted light image within the entire image space of the image divided and converted into units of frames or the image input into units of frames.

When an image area of a specific transmitted light area is selected, the processor 350 may perform the preprocessing on the selected transmitted light image data. For example, the processor 350 may perform preprocessing such as noise removal, filtering, and scaling on the selected transmitted light image data.

After operation S1114 is performed, the processor 350 extracts preset feature information from the preprocessed transmitted light image data (S1116). Here, the feature information may include color, spectral range, brightness, contrast, optical information, texture, frequency, reference scale, edge characteristic information, and various types of image sensing information. The processor 350 may extract the feature information based on the pixels of the transmitted light image.

After operation S1116 is performed, the processor 350 determines whether the transmitted light image data is a ground truth image for the reference sample 20 (S1118).

In order to secure the ground truth image data, which serves as the reference information of the thickness measurement and thickness defect detection of the inspection target product 10, the collection of the ground truth transmitted light image data and the extraction of the feature information data of the reference samples 20 having various thickness values of the same material as the inspection target product 10 are required. Here, the ground truth transmitted light image data may mean the transmitted light image data of the reference samples 20 having various thickness values of the same material as the inspection target product 10.

Accordingly, the processor 350 may determine whether to perform the collection of the ground truth transmitted light image and the extraction of the feature information using new reference samples 20. When the acquisition of the ground truth transmitted light image acquisition and the extraction of the feature information of the new reference samples 20 are not performed, the previously secured ground truth transmitted light image data may be utilized.

As a result of the determination in operation S1118, when the transmitted light image data is the ground truth transmitted light image, the processor 350 separately stores the ground truth transmitted light image data and feature information data collected for each reference sample thickness together with each thickness value information (S1120), and determines whether to generate the AI model (S1122).

As a result of the determination in operation S1122, when the generation of the AI model is necessary, the processor 350 trains individual feature information data of the ground truth transmitted light image to generate the AI model (S1124). That is, the processor 350 may generate the AI model by learning the ground truth transmitted light image data, the feature information data, and the thickness value information. As the known thickness values of the reference samples 20 input into the AI model vary, the ground truth transmitted light image data and the feature information data collected from reference samples 20 may improve the accuracy of thickness measurement and the thickness defect determination of the inspection target product 10.

As a result of the determination in operation S1122, when the generation of the AI model is not necessary, the processor 350 performs the statistical analysis on the feature information of the ground truth transmitted light image for the reference sample 20 (S1126). That is, when the AI model is not generated, the processor 350 may perform the statistical analysis, such as the mean, the standard deviation, and the median, on each individual feature using the feature information of the ground truth transmitted light image for the reference sample 20.

After operation S1126 is performed, the processor 350 calculates and stores an outlier threshold value using the statistical analysis for the feature information of the ground truth transmitted light image (S1128).

In this case, the processor 350 may calculate the outlier threshold value using various statistical methods (e.g., 3-sigma law, Z-Score, Interquartile range (IQR), Grubbs' test, Mahalanobis distance, background modeling, etc.). For example, a formula model for determining the outlier threshold value Tₙ through the 3-sigma law may be expressed as Tⱼ=μⱼ±3σⱼ. Here, u means an average of a data set, and σⱼ means a standard deviation. The processor 350 may select an optimal statistical method by utilizing various data statistical analysis methods.

The outlier threshold value may be used to inspect whether the thickness of the inspection target product 10 is defective later.

As a result of the determination in operation S1118, when the transmitted light image data is not the ground truth transmitted light image data, but the transmitted light image data of the inspection target product 10, the processor 350 determines whether the thickness of the inspection target product 10 is defective by using at least one of the statistical analysis, the AI model, and the difference analysis for the transmitted light image data and the feature information data (S1130).

In this case, the processor 350 may determine whether the thickness of the inspection target product 10 is defective based on the difference between the ground truth transmitted light image data and the individual feature information of the transmitted light image data. For example, the processor 350 may compare the feature information of the ground truth transmitted light image with the feature information of the transmitted light image to determine whether there is individual feature information that has a difference greater than a preset value. As a result of the determination, when the number of feature information having a difference greater than or equal to a certain value between two pieces of feature information is greater than or equal to a preset number, the processor 350 may determine the thickness of the inspection target product 10 as defective. When the number of feature information having a difference greater than or equal to a certain value between two pieces of feature information is not greater than or equal to a preset number, the processor 350 may determine the thickness of the inspection target product 10 as normal.

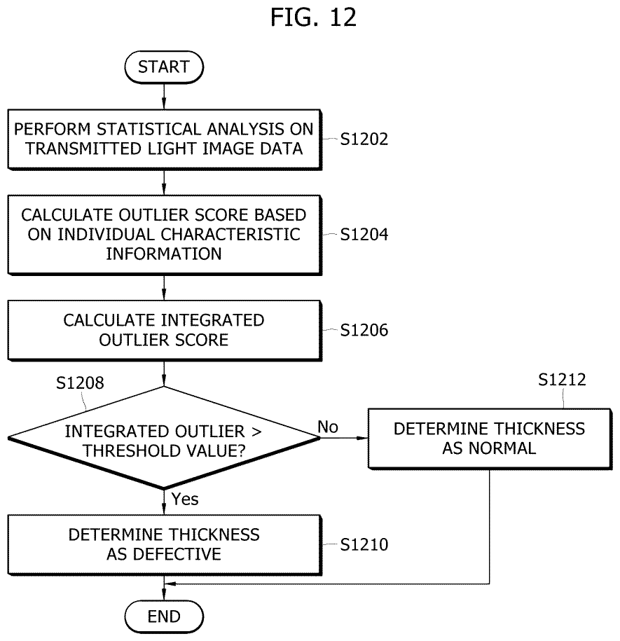

In addition, the processor 350 may perform the statistical analysis on the feature information of the transmitted light image data to determine whether the thickness of the inspection target product 10 is defective. The method for determining whether the thickness of the inspection target product 10 is defective using the statistical analysis will be described in detail with reference to FIG. 12.

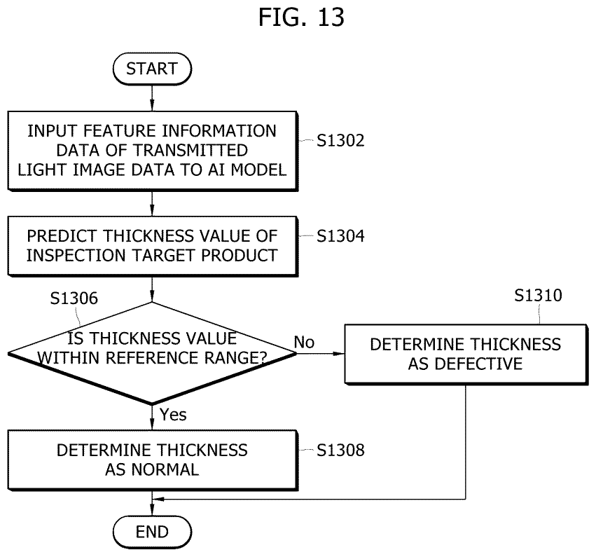

The processor 350 may apply the feature information data of the transmitted light image data to the AI model to determine whether the thickness of the inspection target product 10 is defective. The method for determining whether the thickness of the inspection target product 10 is defective using the AI model will be described in detail with reference to FIG. 13.

When operation S1130 is performed, the processor 350 outputs and stores the result of determining whether the thickness of the inspection target product 10 is defective through the output module 340 (S1132).

FIG. 12 is a flowchart for describing a method of determining whether a thickness of an inspection target product is defective using statistical analysis according to an embodiment of the present invention.

Referring to FIG. 12, the processor 350 performs the statistical analysis on the feature information of the transmitted light image data (S1202). That is, the processor 350 may perform the statistical analysis, such as the average, standard deviation, and median, for each individual feature using the feature information data of the transmitted light image data of the inspection target product 10.

When operation S1202 is performed, the processor 350 calculates the outlier score using the statistical analysis result for each individual feature of the transmitted light image data (S1204).

In this case, the processor 350 may calculate the outlier score (Aⱼ(x)) using the following Equation 1.

$${A}_{j} ( x ) = \frac{{\vert}_{X} - {μ}_{j} \vert}{{σ}_{j}} \qquad [ Equation 1 ]$$

Here, x is an observed feature value, and when there is a data set for each individual feature information Fⱼ of the transmitted light image data, μⱼ may mean the average of the data set, and σⱼ may mean the standard deviation.

When operation S1204 is performed, the processor 350 combines and sums the outlier score and the weight wⱼ for each feature to calculate the integrated outlier score for the transmitted light image data (S1206). That is, the processor 350 may calculate an integrated outlier score Sₜₒₜₐₗ(x) for the transmitted light image data using the following Equation 2.

$${S}_{total} ( x ) = {\sum }_{j = 1}^{n} {w}_{j} \cdot {S}_{j} ( x ) \qquad [ Equation 2 ]$$

Here, n may mean the number of features of the transmitted light image.

When operation S1206 is performed, the processor 350 compares the integrated outlier score with the preset threshold value (S1208).

As a result of the comparison in operation S1208, when the integrated outlier score exceeds the threshold value, the processor 350 determines the thickness of the inspection target product 10 as defective (S1210).

As a result of the comparison in operation S1208, when the integrated outlier score is less than or equal to the threshold value, the processor 350 determines the thickness of the inspection target product 10 as normal (S1212).

FIG. 13 is a flowchart for describing a method of determining whether the thickness of the inspection target product is defective using the AI model according to an embodiment of the present invention.

Referring to FIG. 13, the processor 350 inputs the feature information data of the transmitted light image data to the AI model (S1302), and predicts the thickness value of the inspection target product 10 through the AI model (S1304). The AI model may be a model which trains the feature information data and the thickness values for the reference sample 20 of the same material as the inspection target product 10. Therefore, the processor 350 may predict the thickness value by inputting the feature information data of the inspection target product 10 to the AI model.

When operation S1304 is performed, the processor 350 determines whether the predicted thickness value is within a preset reference range (S1306).

As a result of the determination in operation S1306, when the predicted thickness value is within the reference range, the processor 350 determines the thickness of the inspection target product 10 as normal (S1308).

As a result of the determination in operation S1306, when the predicted thickness value is not within the reference range, the processor 350 determines the thickness of the inspection target product 10 as defective (S1310).

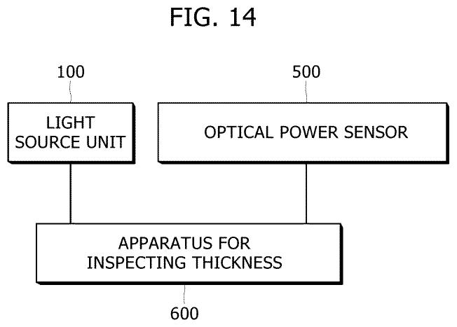

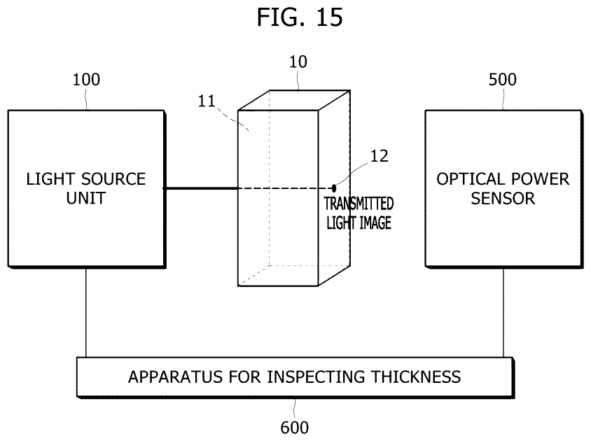

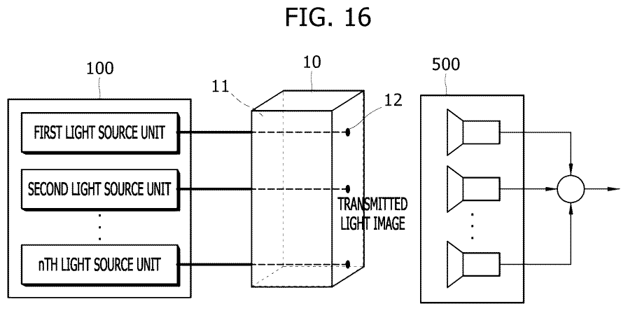

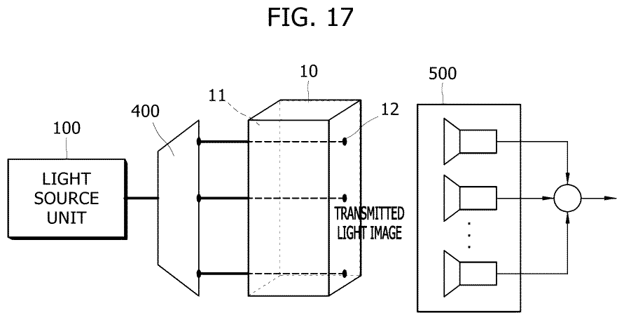

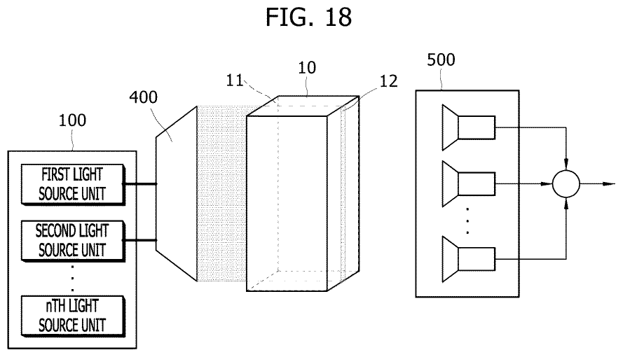

FIGS. 14 and 15 are block diagrams schematically illustrating a system for inspecting a thickness according to another embodiment of the present invention, FIG. 16 is an exemplary diagram for describing a plurality of light source units and a plurality of optical power sensors according to another embodiment of the present invention, FIG. 17 is an exemplary diagram for describing one light source unit, a beam optical system, and a plurality of optical power sensors according to another embodiment of the present invention, and FIG. 18 is an exemplary diagram for describing at least one light source unit, the beam optical system, and the plurality of optical power sensors according to another embodiment of the present invention.

Referring to FIG. 14 and FIG. 15, a system for inspecting a thickness according to another embodiment of the present invention may include a light source unit 100, an optical power sensor 500, and an apparatus 600 for inspecting a thickness.

Since the light source unit 100 is the same as the light source unit 100 illustrated in FIG. 1, a detailed description thereof will be omitted.

The optical power sensor 500 may acquire transmitted light power data of a beam transmitted at a measurement point 12 of an inspection target product 10. That is, the optical power sensor 500 may acquire transmitted light power data of a laser beam transmitted at the measurement point 12 of the inspection target product 10.

The optical power sensor 500 is located at the opposite side of the light source unit 100 with respect to the inspection target product 10, and may measure the transmitted light power data of the beam transmitted by the light irradiated through the light source unit 100.

For example, the optical power sensor 500 may be installed in a position close to the measurement point 12 at an opposite side of an open surface 11 in the inspection target product 10, which has one side of a hexahedron open, as illustrated in FIG. 15.

Therefore, the transmitted light power data of the beam transmitted by the laser beam irradiated through the light source unit 100 at the measurement point 12 may be acquired by the optical power sensor 500 located at the opposite side. For example, as illustrated in FIG. 15, the beam irradiated from the light source unit 100 and transmitted at the measurement point 12 may be measured by the optical power sensor 500 installed at a position close to the light source.

The optical power sensor 500 may transmit the measured transmitted light power data to an apparatus 600 for inspecting a thickness. The transmitted light power data may include optical power sensor identification information and an optical power value.

At least one optical power sensor 500 may be provided to measure the transmitted light power data.

The optical power sensor 500 for measuring transmitted light power data in a band of visible light, infrared light, or ultraviolet light may be selectively applied by the optical power sensor 500 in the band of visible light, infrared light, or ultraviolet light band, respectively, and in particular, an illuminance sensor may be applied in the band of visible light.

Meanwhile, the light source unit 100 and the optical power sensor 500 may use the plurality of light source units 100 and the plurality of optical power sensors 500 as illustrated in FIG. 16 for thickness measurement and thickness defect screening at the plurality of measurement points 12.

In addition, the light source unit 100 and the optical power sensor 500 may use one light source unit 100, the beam optical system 400, and the plurality of transmitted light image acquisition units 500 as illustrated in FIG. 17 to measure the thickness and select the defective thickness at the plurality of measurement points 12. Here, the beam optical system 400 forms a single laser beam irradiated from the light source unit 100 into a multi-point beam, and may be, for example, a beam distributor and beam path converter.

In addition, the light source unit 100 and the optical power sensor 500 may use at least one light source unit 100, the beam optical system 400, and the plurality of transmitted light image acquisition units 500 as illustrated in FIG. 18 to measure the thickness and select the defective thickness at the plurality of measurement points 12. Here, the beam optical system 400 forms a linear laser beam, and may be, for example, a beam distributor and beam path converter. The plurality of optical power sensors 500 may measure transmitted light power data for a line shape beam formed by the beam optical system 400.

Meanwhile, in the present embodiment, the configuration for measuring the transmitted light power is described as the optical power sensor 500, but the optical power sensor 500 may also be referred to as a sensor or a sensor unit.

The apparatus 600 for inspecting a thickness may acquire the measurement point 12 information corresponding to the inspection target product 10, and move the light source unit 100, the beam optical system 400, and the optical power sensor 500 to the position corresponding to the measurement point 12 information.

The apparatus 600 for inspecting a thickness may manage and control operations of at least one of the light source unit 100, the beam optical system 400, and the optical power sensor 500. Here, the functions for managing and controlling the operation of the light source unit 100, the beam optical system 400, and the optical power sensor 500 may include adjusting the position and light intensity of the light source of the light source unit 100 and the beam optical system 400, adjusting the irradiation direction of the laser beam, and adjusting the position of the optical power sensor 500.

The apparatus 600 for inspecting a thickness may inspect whether the inspection target product 10 has a thickness defect using the transmitted light power data collected from the optical power sensor 500.

The apparatus 600 for inspecting a thickness may be implemented as Internet of Things (IoT), a personal computer (PC), a server, an edge device, etc.

The apparatus 600 for inspecting a thickness may include a communication module 310, a memory 320, an input module 330, an output module 340, and a processor 350, as illustrated in FIG. 8.

The memory 320 is a configuration that stores data related to the operation of the apparatus 600 for inspecting a thickness. In particular, the memory 320 may store a program (application or applet) that may inspect whether the thickness of the inspection target product 10 is defective (abnormal) based on the transmitted light power data, and the pieces of stored information may be selected by the processor 350 as needed.

The communication module 310, the memory 320, the input module 330, and the output module 340 is described above in detail with reference to FIG. 8.

The processor 350 may acquire the measurement point information corresponding to the inspection target product 10 and move the light source unit 100 and the optical power sensor 500 to the position corresponding to the measurement point information.

The processor 350 may manage and control the operations of the light source unit 100 and the optical power sensor 500. Here, the function of managing and controlling an operation of at least one of the light source unit 100 and the optical power sensor 500 may include adjustment of the position and light emission intensity of the light source of the light source unit 100 and the beam optical system 400, the adjustment of the irradiation direction of the laser beam, the adjustment of the position of the optical power sensor 500, etc.

The processor 350 may inspect whether the thickness of the inspection target product 10 is defective (abnormal) based on the transmitted light power data received from the optical power sensor 500.

Hereinafter, the operation of the processor 350 inspecting whether the thickness of the inspection target product 10 is defective will be described in detail.

When the inspection target product 10 is selected (or input) through the input module 330, the processor 350 may acquire the measurement point information corresponding to the inspection target product 10 and move the light source unit 100 and the optical power sensor 500 to the position corresponding to the measurement point information.

That is, since the memory 320 stores the measurement point information of each inspection target product 10, when the inspection target product 10 is selected, the processor 350 may acquire the measurement point information corresponding to the selected inspection target product 10. Thereafter, the processor 350 may move the light source unit 100 and the optical power sensor 500 to the position corresponding to the measurement point information. In this case, the light source unit 100 and the optical power sensor 500 may be moved automatically or manually.

The processor 350 may control (or adjust) the light source of the light source unit 100, the position and light emission intensity of the beam optical system 400, the irradiation direction of the laser beam, the position of the optical power sensor 500, etc.

The apparatus 600 for inspecting a thickness may be provided with an actuator (not illustrated) composed of a motor and a gear, a mechanical device, etc., to move the light source unit 100 and the optical power sensor 500, and the movement of the light source unit 100 and the optical power sensor 500 may be controlled by the apparatus 600 for inspecting a thickness.

When the position control of the light source unit 100 and the optical power sensor 500 is completed, the processor 350 may control the light source unit 100 to irradiate the laser beam and control the optical power sensor 500 to measure the transmitted light power data.

Thereafter, the processor 350 may collect the transmitted light power data from the optical power sensor 500 and determine whether the thickness of the inspection target product is defective by using at least one of the statistical analysis, the AI model, and the difference analysis for the collected transmitted light power data.

In this case, the processor 350 may determine whether the thickness of the 10 inspection target product 10 is defective based on the difference between the ground truth transmitted light power data of the reference sample 20 and the collected transmitted light power data. For example, the processor 350 may determine the thickness of the inspection target product 10 as defective when there is a difference greater than a preset value by comparing the ground truth transmitted light power data and the transmitted light power data. When there is no difference greater than or equal to a preset value between the ground truth transmitted light power data and the transmitted light power data, the processor 350 may determine the thickness of the inspection target product 10 as normal.

In addition, the processor 350 may determine whether the thickness of the inspection target product 10 is defective by performing the statistical analysis on the transmitted light power data. That is, the processor 350 may calculate the average and standard deviation of the transmitted light power data of the inspection target product 10 and identify an outlier based on the calculated average and standard deviation. The processor 350 may determine whether the thickness of the inspection target product 10 is defective by comparing the value of the transmitted light power data of the inspection target product 10, excluding the outlier, with the preset threshold value. For example, when the transmitted light power data (value) exceeds the threshold value, the processor 350 may determine the thickness of the inspection target product 10 as defective. When the transmitted light power data (value) is less than or equal to the threshold value, the processor 350 may determine the thickness of the inspection target product 10 as normal. Here, the threshold value may be a value generated based on the reference transmitted light power data of the reference sample 20 of the same material and thickness as the inspection target product 10.

In addition, the processor 350 may determine whether the thickness of the inspection target product 10 is defective by applying the transmitted light power data to the AI model. In this case, the processor 350 may predict the thickness value of the inspection target product 10 through the AI model by inputting the transmitted light power data of the inspection target product 10 to the AI model. The processor 350 may determine whether the predicted thickness value is within a preset reference range. When the predicted thickness value is within the reference range, the processor 350 may determine the thickness of the inspection target product 10 as normal. When the predicted thickness value is not within the reference range, the processor 350 may determine the thickness of the inspection target product 10 as defective.

Here, the AI model may be a model generated based on the ground truth transmitted light image data of the reference sample 20 of various thicknesses of the same material as the inspection target product 10. In other words, the AI model may be a model generated by learning the ground truth transmitted light image data and the thickness value information. The AI model is generated by collecting the ground truth transmitted light image data before acquiring and collecting the transmitted light power data of the inspection target product 10.

The ground truth transmitted light power data acquired from the reference sample 20 with the known thickness may be as illustrated in FIG. 9. The ground truth transmitted light power data, which is acquired by irradiating with the laser beam from the same light source unit 100 the reference samples 20 with different thickness values of the same material, may be as illustrated in FIG. 10. Referring to FIG. 10, it may be confirmed that the transmitted light power data differs depending on the thickness value.

Therefore, as the known thickness values of the reference samples 20 vary, the ground truth transmitted light power data collected from reference samples 20 may improve the accuracy of thickness measurement and the thickness defect determination of the inspection target product 10 input into the AI model.

The AI model may include machine learning (SVM, isolation random forest, etc.), deep learning algorithms (GAN, AutoEncoder, transfer learning, etc.), and may be applied to predict or classify the thickness quality data of products in linkage with the standard-based manufacturing digital twin system.

The processor 350 may output the result of determining whether the inspection target product 10 has a thickness defect through the output module 340 and store the result in the memory 320.

The result of determining whether the thickness of the inspection target product 10 is defective which is stored in the memory 320 may be utilized for linking with the real-time quality management system for the manufactured product or the standard-based manufacturing digital twin model generation and management system. The result of determining whether the thickness of the inspection target product 10 is defective which is stored in the memory 320 may be utilized in linkage with the standard-based manufacturing digital twin model generation and management system to improve and optimize the quality of the manufactured product.

When the thickness of the inspection target product 10 is determined as defective, the processor 350 may output the defect (abnormality) detection information regarding the thickness value of the inspection target product 10 through the output module 34 or notify the preset user of the defect detection information. In this case, the processor 350 may notify the user of the defect (abnormality) detection information of the thickness value of the inspection target product 10 using a text message, email, social networking service (SNS), etc.

In addition, when the thickness of the inspection target product 10 is determined as defective, the processor 350 may re-collect the transmitted light image data, check whether the light source unit 100 and the optical power sensor 500 are operating normally, and perform the function control.

Meanwhile, the system for inspecting a thickness configured as described above may be constructed and utilized as a quality inspection system based on a manufacturing digital twin by being interlinked with a standard-based manufacturing digital twin model generation and management system. The standard-based manufacturing digital twin model generation and management system may be a system that generates and manages a digital twin model for quality management, quality improvement, and productivity enhancement of products required in the manufacturing process. The results of inspecting whether the thickness of the inspection target product 10 is defective (abnormal) stored in the apparatus 600 for inspecting a thickness may be utilized by being interlinked with a standard-based manufacturing digital twin model generation and management system, thereby improving and optimizing the quality of manufactured products.

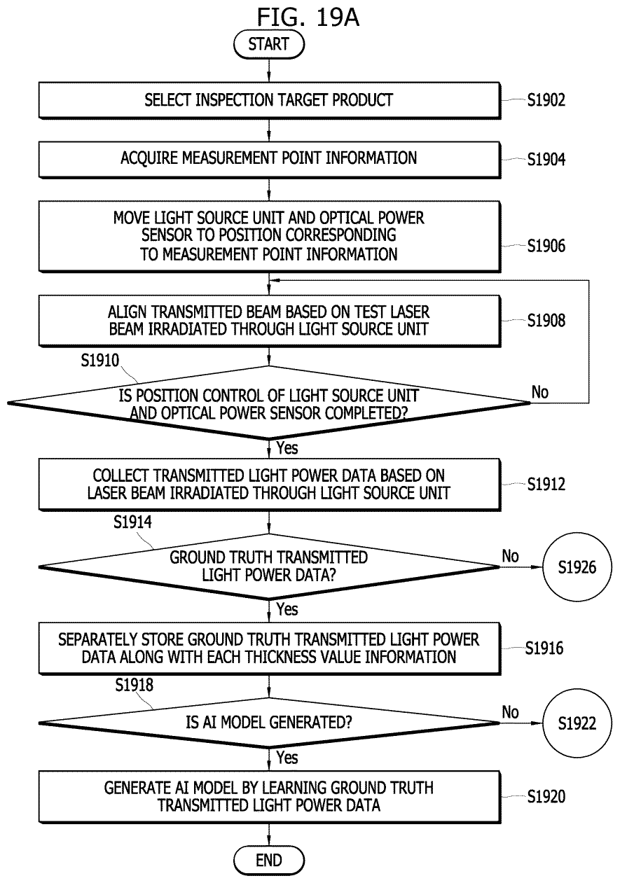

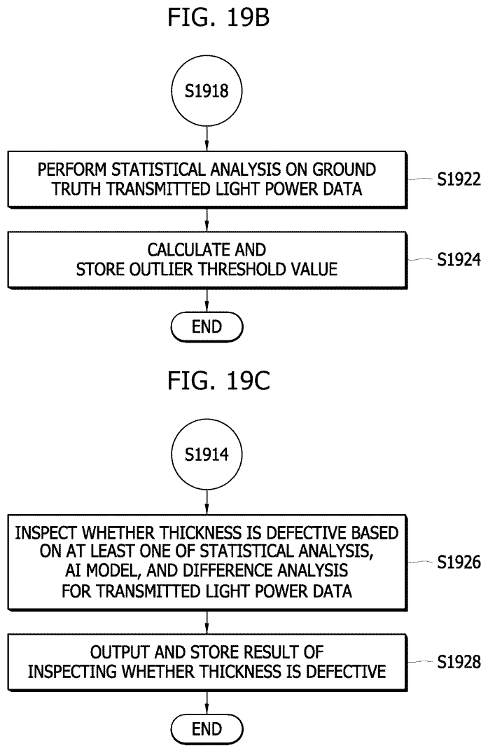

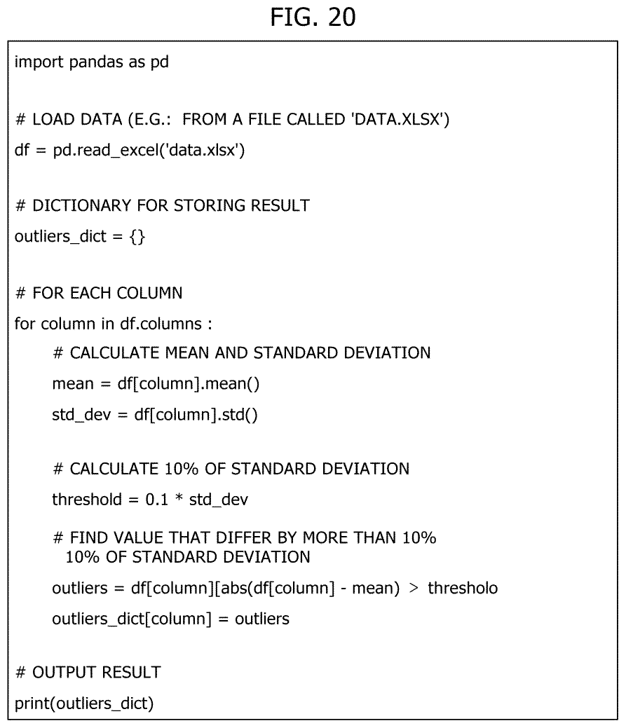

FIGS. 19A to 19C are flowcharts for describing a method of inspecting a thickness of an inspection target product according to another embodiment of the present invention and FIG. 20 is an exemplary diagram illustrating a Python code for a statistical analysis method of transmitted light power data according to another embodiment of the present invention.

Referring to FIGS. 19A to 19C, when the inspection target product 10 is selected (S1902), the processor 350 acquires measurement point information corresponding to the inspection target product 10 (S1904), and moves the light source unit 100 and the optical power sensor 500 to the position corresponding to the measurement point information (S1906). In this case, the processor 350 may adjust the positions of the light source unit 100, the beam optical system 400, and the optical power sensor 500, etc.

When operation S1906 is performed, the processor 350 controls the light source unit 100 to irradiate a test laser beam, and performs the transmitted beam alignment based on the transmitted light power data acquired by the irradiated test laser beam (S1908).

When the light source unit 100 and the optical power sensor 500 move to the measurement point of the inspection target product 10, the processor 350 may control the light source unit 100 to irradiate test light so that the amount of transmitted beam incident on the optical power sensor 500 is maximized. The test light irradiated from the light source unit 100 may be transmitted through the thickness measurement point of the inspection target product 10 to generate the transmitted beam on the opposite side. The optical power sensor 500 may acquire test transmitted light power data generated at the thickness measurement point 12 of the inspection target product 10. The processor 350 may readjust the positions of the light source unit 100 and the optical power sensor 500 so that the acquired test transmitted light image remains is maintained in a clear state and control the light emission intensity and irradiation direction of the light source unit 100, thereby performing the alignment of the transmitted beam. In addition, the processor 350 may adjust the optical power sensor 500 to maintain a state as perpendicular as possible to the light incident beam at a position very close to the measurement point in order to suppress background noise light incident amount excluding the transmitted light area in the test transmitted light power data as much as possible. In addition, the processor 350 may add a calibration process of measuring and storing the optical power sensing value by the background noise light after turning off the light source unit 100. This process may improve the accuracy of the inspection of the thickness quality and the selection of the thickness defect by removing the optical power sensing value by the background noise light in the subsequent measurement data analysis process. In particular, the calibration process may significantly reduce the burden of constructing a darkroom environment to physically block the background noise light.

When the position control for the light source unit 100 and the optical power sensor 500 is completed by performing operation S1108 (S1910), the processor 350 collects the transmitted light image data based on the light irradiated through the light source unit 100 (S1912). That is, the processor 350 may control the light source unit 100 to irradiate a laser beam. The laser light source of the light source unit 100 may generate and irradiate a beam. The beam irradiated from the laser light source of the light source unit 100 is transmitted at the thickness measurement point of the inspection target product 10 and generates the transmitted beam at the opposite side, and the optical power sensor 500 may measure the transmitted light power data of the generated transmitted beam and transmit the measured transmitted light power data to the processor 350.

After operation S1912 is performed, the processor 350 determines whether the transmitted light power data is the ground truth transmitted light power data of the reference sample 20 (S1914).

In order to secure the ground truth transmitted light power data which serves as the reference information of the thickness measurement and the thickness defect detection determination of the inspection target product 10, it is necessary to collect the ground truth transmitted light power data of the reference samples 20 having various thickness values of the same material as the inspection target product 10. Here, the ground truth transmitted light power data may mean the transmitted light power data of the reference samples 20 having various thickness values of the same material as the inspection target product 10.

As a result of the determination in operation S1914, when the transmitted light image data is the ground truth transmitted light power data, the processor 350 separately stores the ground truth transmitted light power data collected for each reference sample thickness together with each thickness value information (S1916), and determines whether to generate the AI model (S1918).

As a result of the determination in operation S1918, when the generation of the AI model is necessary, the processor 350 trains the ground truth transmitted light power data to generate the AI model (S1920). That is, the processor 350 may generate the AI model by learning the ground truth transmitted light power data and the thickness value information. As the known thickness values of the reference samples 20 input into the AI model vary, the ground truth transmitted light power data collected from reference samples 20 may improve the accuracy of thickness measurement and the thickness defect determination of the inspection target product 10.

As a result of the determination in operation S1918, when the generation of the AI model is not necessary, the processor 350 performs the statistical analysis on the ground truth transmitted light power data of the reference sample 20 (S1922). That is, when the AI model is not generated, the processor 350 may perform the statistical analysis, such as the mean, the standard deviation, and the median, on each individual feature using the ground truth transmitted light power data of the reference sample 20.

For example, a method of statistical analysis will be described when light transmission power values for 23 target products are measured (sensed) at the same measurement point. In this case, the processor 350 calculates an average (a) of 23 measured light transmission power values using the following Equation 3.

$$a = \frac{{\sum }_{i = 1}^{23} {x}_{i}}{23} \qquad [ Equation 3 ]$$

Here, xᵢ is each measured light transmission power value.

When the average value of the light transmission power is calculated, the processor 350 calculates the standard deviation (STD) of each light transmission power value using the following Equation 4. This measures how much each measurement value deviates from the average.

$${STD}_{a} = \sqrt{\frac{{\sum }_{i = 1}^{23} {( {x}_{i} - a )}^{2}}{23}} \qquad [ Equation 4 ]$$

The processor 350 may identify measurement data that deviate from the average by more than 10% of the standard deviation as an outlier. In other words, the processor 350 may identify xᵢ that satisfies the following Equation 5 as an outlier.

$${x}_{i} > a + ( 0.1 * {STD}_{a} ) or {x}_{i} < a - ( 0.1 * {STD}_{a} ) \qquad [ Equation 5 ]$$

As described above, the processor 350 calculates the average and standard deviation for the 23 measured transmitted light power values, and identifies outliers that are significantly deviating from the average based on the results, and these outliers may be considered as data with abnormal or defective patterns in the data set and used for quality control.

The data statistical analysis implemented as a Python code is as illustrated in FIG. 20.

When operation S1922 is performed, the processor 350 calculates and stores the outlier threshold value using the statistical analysis for the ground truth transmitted light power data (S1924).

In this case, the processor 350 may calculate the outlier threshold value using various statistical methods (e.g., 3-sigma law, Z-Score, Interquartile range (IQR), Grubbs' test, Mahalanobis distance, background modeling, etc.). For example, the formula model for determining the outlier threshold value Tₙ through the 3-sigma law may be expressed as Tⱼ=μⱼ+30j. Here, μⱼ means the average of the data set, and σⱼ means the standard deviation. The processor 350 may select an optimal statistical method by utilizing various data statistical analysis methods.

The outlier threshold value may be used to inspect whether the thickness of the inspection target product 10 is defective later.

As a result of the determination in operation S11914, when the transmitted light power data is not the ground truth transmitted light power data, but the transmitted light power data of the inspection target product 10, the processor 350 determines whether the thickness of the inspection target product 10 is defective by using at least one of the statistical analysis, the AI model, and the difference analysis for the transmitted light power data (S1926).

In this case, the processor 350 may determine whether the thickness of the inspection target product 10 is defective based on the difference between the ground truth transmitted light power data and the transmitted light power data. For example, the processor 350 may determine the thickness of the inspection target product 10 as defective when there is a difference greater than a preset value by comparing the ground truth transmitted light power data and the transmitted light power data. When there is no difference greater than or equal to a preset value between the ground truth transmitted light power data and the transmitted light power data, the processor 350 may determine the thickness of the inspection target product 10 as normal.

The processor 350 may determine whether the thickness of the inspection target product 10 is defective by performing the statistical analysis on the transmitted light power data. That is, the processor 350 may calculate the average and standard deviation of the transmitted light power data of the inspection target product 10 and identify an outlier based on the calculated average and standard deviation. The processor 350 may determine whether the thickness of the inspection target product 10 is defective by comparing the value of the transmitted light power data of the inspection target product 10, excluding the outlier, with the preset threshold value. For example, when the transmitted light power data (value) exceeds the threshold value, the processor 350 may determine the thickness of the inspection target product 10 as defective. When the transmitted light power data (value) is less than or equal to the threshold value, the processor 350 may determine the thickness of the inspection target product 10 as normal. Here, the threshold value may be a value generated based on the ground truth transmitted light power data of the reference sample 20 of the same material and thickness as the inspection target product 10.

The processor 350 may determine whether the thickness of the inspection target product 10 is defective by applying the transmitted light power data to the AI model. In other words, the processor 350 may predict the thickness value of the inspection target product 10 through the AI model by inputting the transmitted light power data of the inspection target product 10 to the AI model. The processor 350 may determine whether the predicted thickness value is within a preset reference range. When the predicted thickness value is within the reference range, the processor 350 may determine the thickness of the inspection target product 10 as normal. When the predicted thickness value is not within the reference range, the processor 350 may determine the thickness of the inspection target product 10 as defective.

When operation S1926 is performed, the processor 350 outputs and stores the result of determining whether the thickness of the inspection target product 10 is defective through the output module 340 (S1928).

According to the system for inspecting a thickness and a method according to some embodiments of the present invention, by measuring the thickness of the inspection target product in the non-contact, non-destructive method by using the laser light source in the band of at least one of visible light, infrared light, and ultraviolet light and the transmitted light image acquisition unit 200 capable of recognizing the image in the wavelength band of the corresponding light source or the optical power sensor 500 in the band of at least one of visible light, infrared light, and ultraviolet light, it is possible to accurately measure the thickness at the measurement point of the product within the narrow error range, thereby enabling the difference in the relative thickness to be accurately detected with the narrow error range.

According to the system and method for inspecting a thickness according to some embodiments of the present invention, by irradiating at least one laser light among visible light, infrared light and ultraviolet light, which is propagated at a very narrow solid angle, to the measurement points of the light-transmitting product whose thickness is to be measured, analyzing the image of the laser light pattern transmitted and scattered to the opposite side of the corresponding measurement point or the received optical power to measure the thickness and select the defective thickness products from the measurement, it is possible to measure the thickness in the quantitative manner without damaging the inspection target product and easily select the defective thickness products the measurement, thereby significantly reducing the time for selecting the defective thickness products at various points.

According to the system and method for inspecting a thickness according to some embodiments of the present invention, by using at least one laser light among visible light, infrared light, and ultraviolet light, which maintains the very narrow solid angle and whose optical power is spatially limited and propagated with almost no loss within a distance of several meters, it is possible to quantitatively and accurately know the incident optical power irradiated to the measurement point, and by determining the measured light reception power on the other side only by the laser light power irradiated to the measurement point and the transmittance due to the thickness of the measurement point, it is possible to measure the thickness with a very narrow error range, thereby selecting the defective thickness products with very high accuracy.

The system and method for inspecting a thickness according to some embodiments of the present invention may be easily applied to the manufacturing process of the related industrial site that requires the thickness measurement of the manufactured product and the selection inspection of the defective thickness products, so it is possible to greatly contributing to the efficiency and automation of the related manufacturing process.

Although the present invention has been described with reference to embodiments shown in the accompanying drawings, it is only an example. It will be understood by those skilled in the art that various modifications and equivalent other exemplary embodiments are possible from the present invention. Accordingly, a true technical scope of the present invention is to be determined by the spirit of the appended claims.

What is claimed is:

1. A system for inspecting a thickness, comprising:
at least one light source unit that irradiates an inspection target product with light;
a sensor unit that acquires transmitted light image data or transmitted light power data of light transmitted through the inspection target product; and
an apparatus for inspecting a thickness that inspects whether the thickness of the inspection target product is defective based on the transmitted light image data or the transmitted light power data.

2. The system of claim 1, wherein the light source unit irradiates laser light.

3. The system of claim 2, wherein the light source unit is composed of a laser light source of at least one of visible light, infrared light, and ultraviolet light according to transmission characteristics of at least one of visible light, infrared light, and ultraviolet light of a material of the inspection target product.

4. The system of claim 1, wherein the sensor unit includes at least one transmitted light image acquisition unit that acquires the transmitted light image data, and the transmitted light image acquisition unit is located at an opposite side of the light source unit with respect to the inspection target product, and acquires the transmitted light image data appearing on the inspection target product by transmitting the light irradiated through the light source unit.

5. The system of claim 1, wherein the sensor unit includes at least one optical power sensor that acquires the transmitted light power data, and
the optical power sensor is located at the opposite side of the light source unit with respect to the inspection target product, and measures transmitted light power data of a beam appearing on the inspection target product by transmitting the light irradiated through the light source unit.

6. The system of claim 1, further comprising a beam optical system that forms the light irradiated from the light source unit into a multi-point beam or a line shape beam and irradiates the inspection target product with the formed multi-point beam or line shape beam.

7. The system of claim 1, wherein the apparatus for inspecting a thickness includes:
a memory; and
a processor that is connected to the memory, and
the processor adjusts a position of at least one of the light source unit and the sensor unit, and inspects whether the thickness of the inspection target product is defective based on the transmitted light image data or the transmitted light power data.

8. The system of claim 7, wherein the processor acquires measurement point information corresponding to the inspection target product, moves at least one of the light source unit and the sensor unit to a position corresponding to the measurement point information, and adjusts at least one of light emission intensity and a light irradiation direction of the light source unit.

9. The system of claim 7, wherein the processor extracts feature information data from the transmitted light image data, and determines whether the thickness of the inspection target product is defective based on the transmitted light image data and the feature information data.

10. The system of claim 9, wherein the processor inputs the transmitted light image data and the feature information data to an artificial intelligence (AI) model to predict a thickness value of the inspection target product, and when the thickness value is not included within a preset reference range, determines the thickness of the inspection target product as defective, and
the AI model is a model generated by learning ground truth transmitted light image data, feature information data, and thickness value information of reference samples with various thicknesses being the same material as the inspection target product.

11. The system of claim 9, wherein the processor performs statistical analysis on individual feature information included in the feature information data, calculates outlier scores using the statistical analysis result of the individual feature information, applies a weight to the outlier scores for each individual feature information to calculate an integrated outlier score, and compares the integrated outlier score with a preset threshold value to determine whether the thickness of the inspection target product is defective.

12. The system of claim 9, wherein the processor calculates a difference between the feature information data and the feature information data of pre-stored ground truth transmitted light image data, and determines whether the thickness of the inspection target product is defective based on the calculated difference.

13. The system of claim 7, wherein the processor inputs the transmitted light power data to an AI model to predict a thickness value of the inspection target product, and, when the thickness value is not included within a preset reference range, determines the thickness of the inspection target product as defective, and
the AI model is a model generated by learning ground truth transmitted light power data and thickness value information of reference samples with various thicknesses being the same material as the inspection target product.

14. The system of claim 7, wherein the processor calculates an average and a standard deviation of the transmitted light power data, identifies outliers based on the calculated average and standard deviation, and compares the transmitted light power data from which the outliers are excluded with a preset threshold value to determine whether the thickness of the inspection target product is defective.

15. The system of claim 7, wherein the processor calculates a difference between the transmitted light power data and pre-stored ground truth transmitted light power data, and determines whether the thickness of the inspection target product is defective based on the calculated difference.

16. A method of inspecting a thickness, comprising:
collecting, by a processor, transmitted light image data of light transmitted through an inspection target product;
extracting, by the processor, feature information data from the transmitted light image data; and
inspecting, by the processor, whether a thickness of the inspection target product is defective based on the feature information data of the transmitted light image data.

17. The method of claim 16, further comprising, before the collecting of the transmitted light image data, acquiring, by the processor, measurement point information corresponding to the inspection target product, moving at least one of a light source unit and a transmitted light image acquisition unit to a position corresponding to the measurement point information, and adjusting at least one of light emission intensity and a light irradiation direction of the light source unit.

18. The method of claim 16, wherein, in the inspecting of whether the thickness of the inspection target product is defective, the processor inspects whether the thickness of the inspection target product is defective by using at least one of statistical analysis, an artificial intelligence (AI) model, and difference analysis for the transmitted light image data and the feature information data.

19. A method of inspecting a thickness, comprising:
collecting, by a processor, transmitted light power data of light transmitted through an inspection target product; and
inspecting, by the processor, whether a thickness of the inspection target product is defective based on the transmitted light power data.

20. The method of claim 19, further comprising, before the collecting of the transmitted light power data, acquiring, by the processor, measurement point information corresponding to the inspection target product, moving at least one of a light source unit and an optical power sensor to a position corresponding to the measurement point information, and adjusting at least one of light emission intensity and a light irradiation direction of the light source unit.
